(19) United States
(12) Patent Application Publication
(10) Pub. No.: US 2008/0172923 A1
(43) Pub. Date: Jul. 24, 2008

(54) Cobra fishing lure

(76) Inventor: James Nicholson, Willoughby Hills, OH (US)

Correspondence Address: JAMES NICHOLSON, 27400 CHARDON RD., # 232, WILLOUGHBY HILLS, OH, 44092, US

(21) Appl. No.: 11/656,228

(22) Filed: Jan. 20, 2007

(51) Int. Cl. A01K 85/10

(52) U.S. Cl. 43/42.19

(57) ABSTRACT

The present invention replaces the conventional spinning blade with a Cobra spoon and eliminates the clevis. Cobra spoon has a head and a wing. The wing has a convex and a concave surface. The head of the spoon is bent against concave surface of the wing to form an angle of 120 degrees, not less than 90 degrees. The Cobra coastlock snap with a proximal eyelet, a main long arm, a secondary short arm, and a distal eyelet supports all lure's components. The proximal eyelet is attached to the line. The body weight, the bead, and Cobra spoon are mounted directly on main arm. The secondary arm in closed position locks the body weight, sustains the bead, which is the bearing for Cobra spoon, and secures the hook in distal eyelet. The Cobra coastlock snap in open position releases the hook and gives a fisherman the possibility to choose any hook or fly in accordance with fishing circumstances.

### CROSS-REFERENCES TO RELATED APPLICATIONS

Not Applicable

### STATEMENT REGARDING FEDERALLY SPONSORED RESEARCH OR DEVELOPMENT

Not Applicable

### REFERENCES TO SEQUENCE LISTING A TABLE, OR A COMPUTER PROGRAM LISTING COMPACT DISC APPENDIX

Not Applicable

### BACKGROUND OF THE INVENTION

The present invention pertains to fishing lures used for spin casting. More specifically, the present invention relates to spinning fishing lures and has been designated to produce a lure having an action that accurately simulates the appearance of a natural insect, particularly a moth.

The major objectives of the present invention are to provide one of the spinning fishing lures that combine simplicity to manufacture with efficiency in the water.

The angle of 120 degrees between the proximal and distal end of the spoon imitating the head and the wings of the moth, the concavity of distal end of the spoon facing the body lure, and with direct assembly of the spoon to the lure's spindle make this lure unique on the market.

The particularly motion of the spoon in the water of the present invention substantially eliminates line twist, which is responsible for the damage of the fishing line, and reduces the fisherman's expenses.

### BRIEF SUMMARY OF THE INVENTION

The present invention comprises a fishing lure having an elongated coastlock snap, a spinner spoon, a bead, a weighted body, and a hook.

The spinning spoon of the present invention is fastened directly to the lure's spindle, in this case the main wire of coastlock snap, with no intervening elements. The invention eliminates the conventional mounting of spinning spoon by a clevis or stirrup. The spoon has two distinctive ends. An angle of 120 degrees between the proximal and distal end of the spoon allows the spinner spoon to revolve almost parallel about the body lure's centerline. A deep dive is obtainable through selection of size of the spoon, or weight of the body, or combination of body weight and spoon size. It will be understood that the size of the spinning spoon and body lure's weight may vary from small size to large size depending from fish size desired to catch.

The concave surface of the distal end of the spoon, or wing will face the lure's body, and the opposite side, which is the convex face, will reflect the light in the water. The vibration produced by the spinning spoon and the alternation between light and shade produced by the convex and concave faces of the spinning spoon will tent the fish to strike.

One bead, preferably from plastic, slideable on main long arm of coastlock snap constitutes the bearing surface against which the spoon rotates.

The body lure of this invention looks like an elongated coastlock snap. The main arm of coastlock snap manufactured from stainless steel wire sustains the body weight made from plastic tube or metal, preferably silver or brass color. The body weight can have a tubular or bullet shape with different weights.

This invention with a lure's body in a coastlock snap shaped form gives to the fisherman the advantage to change the hook any time, anywhere in accordance with fishing conditions from single hook, to treble hook, or fly in any size and color. The present invention simulates so perfect a natural insect, the moth, that the fish will strike in many times when the lure will touch the water surface. The particularly angle of the spoon and the rate of rotation will reduce to minimum the line twist. The angle and position of the spoon to the lure's body is responsible for diminishing the noise when the lure, after casting, will hit the water surface.

Casting with this lure at highest distance then others fishing lures on the market with same weight will be another important advantage. The directly mounted spoon on main long arm of coastlock snap and the angle between the head and wing of the spoon will keep the spoon close to the body lure, and the friction in the air due to casting will be significantly diminished.

### BRIEF DESCRIPTION OF THE DRAWING

FIG. 1 is a front view of the lure exposing the concave face of the spinning spoon and components of the body lure.

FIG. 2 is a front view of the lure with spinning spoon exposing the convex face.

FIG. 3 is a perspective view of the lightweight variation of the body lure.

FIG. 4 is a perspective view of the medium or heavy weight of the body lure.

FIG. 5 is a front view of the bead or spoon bearing.

FIG. 6 is a front view of the convex face of the spinning spoon.

FIG. 7 is a front view of the plastic tube used for lightweight body lure.

FIG. 8 is a front view of the body lure weight from brass used for medium and heavy weight lure.

FIG. 9 is a side view of the spinning spoon exposing an angle of 120 degrees between the head and wing of the spoon.

FIG. 10 is a perspective view of the lure exposing the concave face of the spoon and all parts of the body lure. The coastlock snap is in unlocked position.

FIG. 11 is the image of the previous FIG. 10 with coastlock snap in a locked position.

FIG. 12 is a side view of the lure exposing the angle between the proximal end or head and distal end or wing of the spinning spoon.

### DETAILED DESCRIPTION OF THE INVENTION

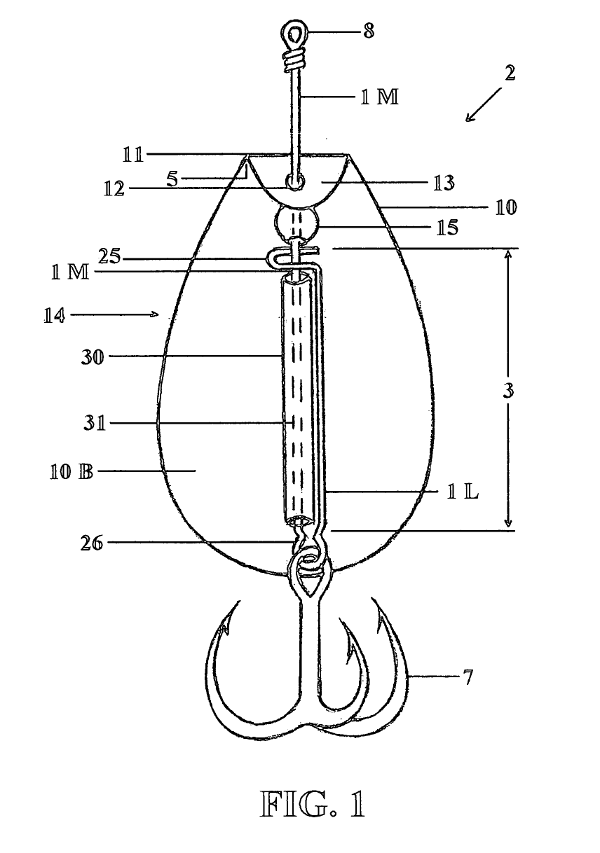

Referring to the drawings, in FIG. 1 the fishing lure 2 illustrates the preferred embodiment of the invention for lightweight lure variation. The fishing lure 2 of present invention includes five distinctive components: an elongated coastlock snap 25 with a new designed form, adapted for present invention; a spinning spoon 14 with a new concept in art, which has an angle of 120 degrees 5 between the proximal end 13 and distal end 10; a bead 15; an elongated body lure 3; and a hook 7.

The coastlock snap 25 manufactured of stainless steel wire, used for present invention are novel of art due to a long main arm 1M, a secondary short arm 1L, and a new distal eyelet 26, to retain and secure a fishing hook 7. The distal eyelet 26 is formed from distal end of main arm 1M and distal end of secondary arm 1L of coastlock snap 25. The coastlock snap 25 with this particularly elongated construction will support all the components of lure 2. On main arm 1M will be mounted the body weight 30, the bead 15, and the spinning spoon 14. The fishing hook 7 will be retained and secured in eyelet 26, the distal end of the coastlock snap 25. The proximal end of the main arm 1M is bent to form a proximal eyelet 8 to be attached to a fishing line. For simplicity the embodiments show no fishing line attached.

The long arm 1M of elongated coastlock snap 25 will be at same time the spindle or shaft for rotative spoon 14 and the main longitudinal axis of lure 2, reason to have for main arm or shaft, or spindle, or longitudinal axis of lure same notation 1M. The proportion between the length of the main arm 1M and the length of secondary arm 1L of coastlock snap 25 depends of spoon's size and body weight. In general, the secondary arm 1L is ½ from the length of the main arm 1M.

Referring to the drawings, in FIG. 1 through FIG. 12 the reference numeral 13 is used to define only the head or proximal end of the spoon 14. The reference numeral 10 is used to define only the wing or distal end of the spoon 14. The reference numeral 14 is used to define the entire spoon. The spoon 14 has a convex surface 10A, a concave surface 10B, a proximal end 13, and a distal end 10. The proximal end 13 is bent against the concave surface 10B of distal end 10 to form an angle of 120 degrees. Continuing to bend, the angle will decreased to 90 degrees. The result will be a new type of spoon: the Cobra spoon. Any angle between 120 degrees and 90 degrees will have a lure with good results.

Due to a centered hole 12 of head 13 the spinning spoon 14 is directly mounted, without any intermediary parts, to the main arm 1M of coastlock snap 25. In this particularly mounted lure, the main arm 1M becomes the spindle or shaft for rotative spoon 14. The concave surface 10B of the wing 10 will face always the body lure 3. The length of the longitudinal axis of the spoon 14 must be at least the length of body lure 3 and bead 15 added together.

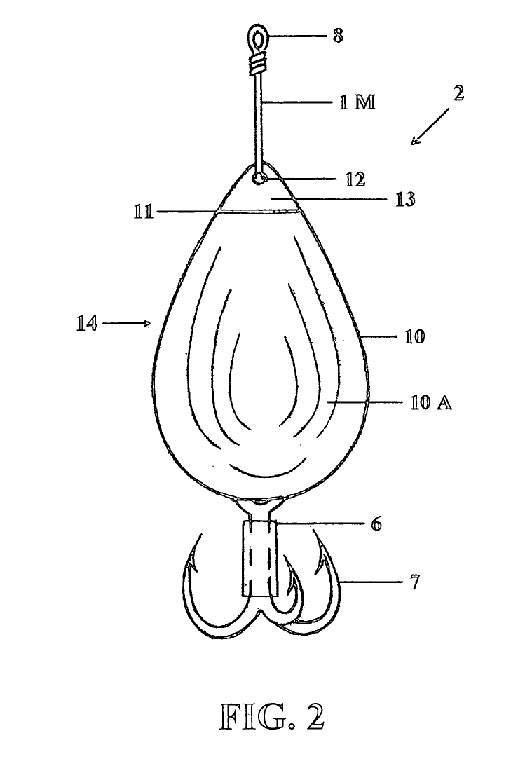

FIG. 2 shows the convex surface 10A of the distal end of the spoon 14, and it is visible the demarcation line between the proximal end 13 and distal end 10 of the spoon 14. The hole 12 has 1.0 mm in diameter if 1M wire has 0.8 mm.

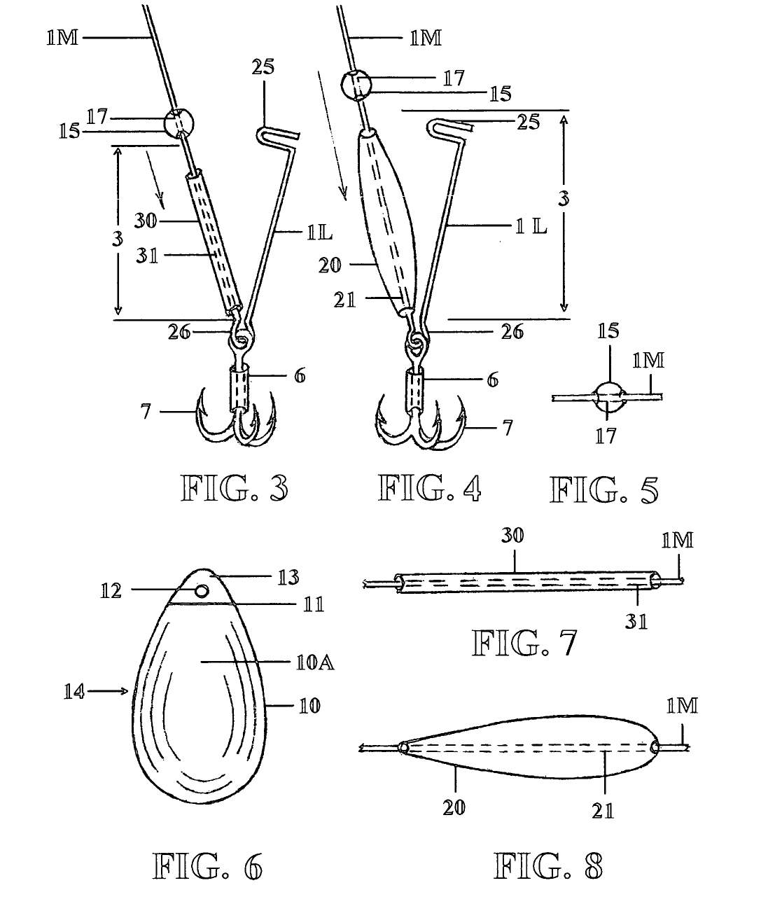

FIG. 3 illustrates an elongated coastlock snap 25 in opened position. The fishing hook 7 is retained in distal eyelet 26. On main arm 1M is mounted the body weight 30 slidable due to a lumen 31 running throughout from proximal end to distal end, and a bead 15 slidable due to a lumen 17. The body weight 30 has a cylindrical shape, used for lightweight lure. The body weight 30, the distal half of main long arm 1M, and the short arm 1L of the coastlock snap 25 form together the body lure 3.

FIG. 4 shows a different shape of body weight 20 with a lumen 21. The body weight 20 is slidable on arm 1M and he has an elongated form to give more stability and proportional dispersion of the body weight 20 along the main arm 1M, which is the main axis of the lure 2.

FIG. 5 illustrates the bead 15 with a lumen 17. Mounted and sliding on the arm 1M constitutes the bearing surface against which the spoon 14 rotates. Various sizes and colors of bead may be used, depending of the spoon size and body weight.

FIG. 6 illustrates the shape of the spoon 14. Will be understood that various sizes of spoons may be used depending of fish size desired to catch. The spoon 14 may be decorated or painted. The material of which the spoon is manufactured will preferably be of brass sheet with 1 mm in thickness.

FIG. 7 illustrates the shape of the body weight 30. This particularly shape is preferable for lightweight spinning spoon and manufactured from tubular plastic in various colors or light metal.

FIG. 8 illustrates the shape of body weight 20 preferably for medium and heavy weight lure manufactured of brass.

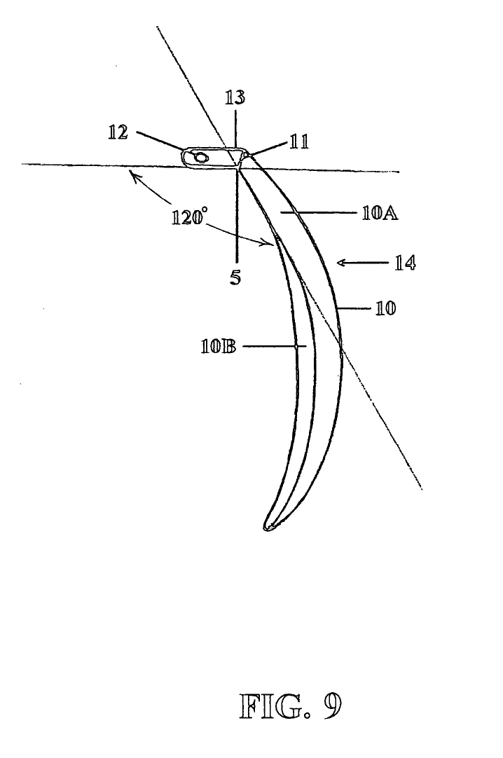

FIG. 9 shows more accurate the angle 5 of 120 degrees between the proximal end 13 and distal end 10 of the spoon 14. From side view, the proximal end 13 of spoon 14 will be the head, and the distal end 10 will be the wing. This figure also illustrates more visible the convex surface 10A and concave surface 10B of the spoon 14. This angle provides a new lure, which is of novel construction, and in the water has a novel action. From this side view, is more clearly why the proximal end 13 is named head and distal end 10 is named wing of the spoon 14. Also this figure shows clearly why this type of spoon is named Cobra spoon due to the angle 5 of 120 degrees.

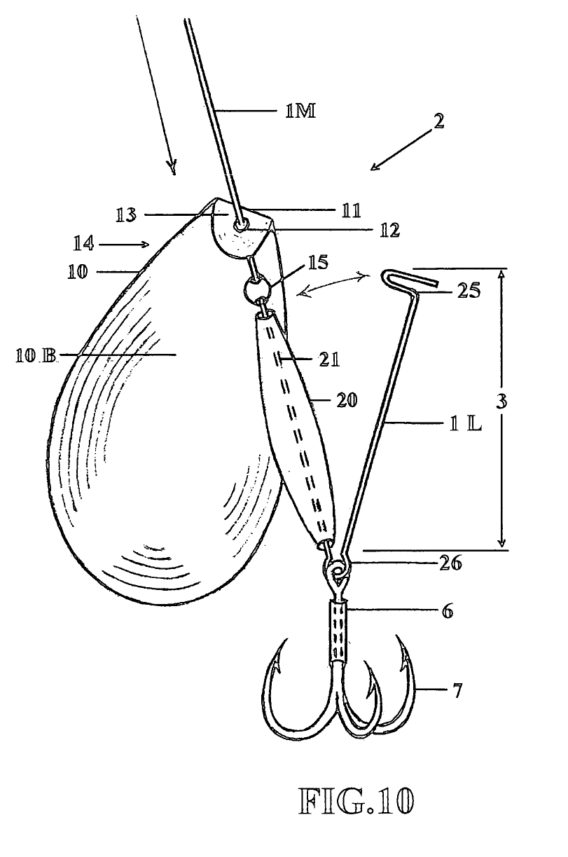

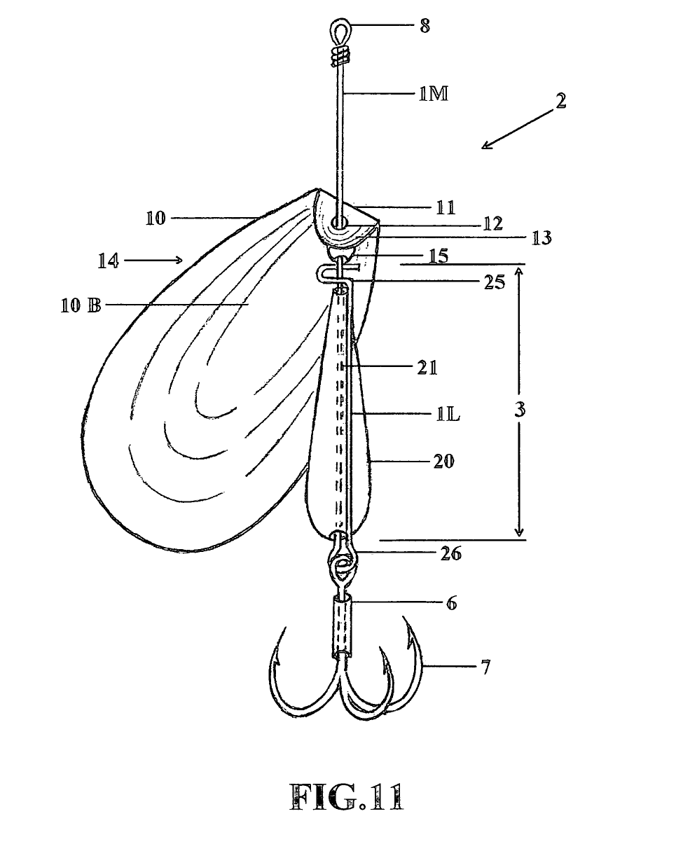

FIG. 10 illustrates the fishing lure 2 with coastlock snap 25 in unlocked position and shows the sequential mounting of the lure's components. First will be mounted the body weight 20, second the bead 15, third the spinning spoon 14 with concave surface 10B facing the body lure 3. After all the lure's elements were mounted, will be manufactured the proximal eyelet 8 of main arm 1M. The fishing hook 7 will be mounted or changed always through the short arm 1L of the coastlock snap 25 in unlocked position. Due to the elasticity of the long arm 1M and short arm 1L of the coastlock snap 25, in open position, the distal eyelet 26 will be opened and will release the fishing hook 7.

FIG. 11 shows the fishing lure 2 in greater detail with an elongate coastlock 25 in locked position. The fishing hook 7 will be retained and secured in distal eyelet 26. The body weight 20 mounted on main arm 1M is locked between the proximal end of the short arm 1L and distal eyelet 26. The short arm 1L will be like a quick-clip clasp. The bead 15 will be sustained by the proximal end of short arm 1L, and will be the bearing for spoon 14.

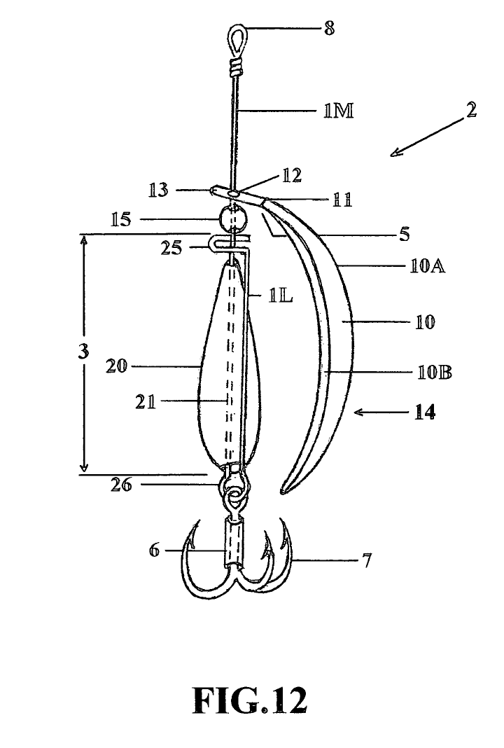

Referring to the FIG. 12, the bead 15 and the body lure 3, which is formed from body weight 20 and distal end of coastlock snap 25 in locked position, are more visible due to position of the spoon 14. FIG. 12 shows more relevant the angle 5 of 120 degrees between head 13 and wing 10 of the spoon 14. Also shows the position of the spoon 14 almost parallel with body lure 3. The concave surface 10B and convex surface 10A of the spoon 14 are more evident.

The fishing hook 7 can be simple hook, double hook, treble hook, or fly depending of the fish desired to catch. Dressing material can be selected as feather, plastic tube 6, or buck tail in different colors.

The principle of the invention has been shown and the invention has been described with reference to preferred embodiments. It is to be understood that modification will occur and the invention is not intended to be limited except as recited in the following claims.

What I claim as my invention is:

1. A fishing lure comprising:
a) A Cobra coastlock snap including a proximal eyelet, a distal eyelet, a main long arm, and a short secondary arm. The length proportion between main long arm and secondary short arm of coastlock snap is 2:1.
b) A line attachment eyelet disposed at the proximal end of main long arm of coastlock snap.
c) Fishing lure's elements: body weight, bead, and Cobra spoon mounted directly on main arm of coastlock snap. In open position of coastlock snap the lure's elements are slideable on main arm.
d) A Cobra spoon with an angle of 120 degrees between head and wing, not less than 90 degrees, and with a convex and concave surface of the wing. Cobra spoon is mounted directly on main arm of coastlock snap with concave surface of wing facing the body lure. The centered hole of spoon's head will be at least 1.0 mm in diameter.
e) A bead mounted on main arm of coastlock snap to be the bearing for spoon.
f) A body lure including the body weight, the distal half of main arm, and the secondary arm of coastlock snap which in closed position will secure the body weight.
g) A fishing hook attachment eyelet disposed at distal end, formed from main arm and secondary arm of coastlock snap. In open position of coastlock snap the hook will be released to be changed with any type of hook.

2. The lure of claim 1 wherein the spoon has an angle of 120 degrees, but not less than 90 degrees, between the head and the wing of Cobra spoon. The head of Cobra spoon is bent against the concave surface of the wing.

3. The lure of claim 1 wherein the spoon is mounted directly on main arm of elongated coastlock snap.

4. The lure of claim 1 wherein the body weight of the lure is mounted directly on the main arm of coastlock snap and secured by the secondary arm in locked position.

5. The lure of claim 1 wherein the bead mounted on the main arm, which is the bearing for spoon, is sustained by the proximal end of short arm of coastlock snap in closed position.

6. The lure of claim 1 wherein the hook is retained and secured by distal eyelet of elongated coastlock snap.

7. The lure of claim 1 wherein the Cobra spoon, the bead, and the body weight is mounted on a Cobra coastlock snap.
